(19) United States
(12) Patent Application Publication
(10) Pub. No.: US 2026/0249473 A1
(43) Pub. Date: Aug. 27, 2026

(54) ROBOT, ROBOT CONTROLLER, AND WORK ROBOT SYSTEM

(71) Applicant: FANUC CORPORATION, Minamitsuru-gun, Yamanashi (JP)

(72) Inventors: Wataru MIYAZAKI, Yamanashi (JP); Kentaro KOGA, Yamanashi (JP)

(73) Assignee: FANUC CORPORATION, Minamitsuru-gun, Yamanashi (JP)

(21) Appl. No.: 18/854,276

(22) PCT Filed: Apr. 26, 2022
(86) PCT No.: PCT/JP2022/018967

§ 371 Date: Oct. 4, 2024

(51) Int. Cl. B25J 9/16; B25J 9/00

(52) U.S. Cl. CPC B25J 9/1697; B25J 9/0093; B25J 9/1664

(57) ABSTRACT

A robot including an arm, and a controller that controls the arm, wherein the robot is configured to perform a predetermined work on a target portion of an object which is being moved by an object conveying device. The controller is configured to perform a waypoint following control which controls the arm so that a component or a tool supported by a distal end portion of the arm follows the object, which is being moved, at each of one or more waypoints before moving the component or the tool to a work start position; and after executing the waypoint following control, control the arm to place the component or the tool at the work start position and control the arm to perform a work time following in which the component or the tool follows the object.

This application is a national phase of International Application No. PCT/JP2022/018967 filed Apr. 26, 2022, which is incorporated herein by reference in its entirety.

### TECHNICAL FIELD

The present disclosure relates to a robot, a robot controller, and a work robot system.

### BACKGROUND ART

In the related art, there is often a case in which a conveying device is stopped to assembly a component to an object which is being conveyed by a conveying device. Especially, it is necessary to stop objects being conveyed by the conveying device to assembly the component to a large object such as a vehicle body and the like. This may leads to a decrease in work efficiency of the system.

On the other hand, a robot system in which a robot follows an object or the like which is being moved by a conveying device is known. See, for example, PTL 1 to 3.

### CITATION LIST

### Patent Literature

Japanese Unexamined Patent Application, Publication No. 2011-140084

Japanese Unexamined Patent Application, Publication No. S62-241684

Japanese Unexamined Patent Application, Publication No. 2007-090479

### SUMMARY OF INVENTION

A first aspect of the present invention is a robot including an arm; and a controller that controls the arm, wherein the robot is configured to perform a predetermined work on a target portion of an object which is being moved by an object conveying device, wherein the controller is configured to perform: a waypoint following control which controls the arm so that a component or a tool supported by a distal end portion of the arm follows the object, which is being moved, at each of one or more waypoints before moving the component or the tool to a work start position of the predetermined work; and after executing the waypoint following control, a work time following control which controls the arm to place the component or the tool at the work start position and which controls the arm to perform a work time following in which the component or the tool follows the object which is

A second aspect of the present invention is a robot controller wherein the robot controller is configured to control an arm of a robot that performs a predetermined work on a target portion of an object which is being moved by an object conveying device, wherein the robot controller is configured to perform: a waypoint following control which controls the arm so that a component or a tool supported by a distal end portion of the arm follows the object, which is being moved, at each of one or more waypoints before moving the component or the tool to a work start position of the predetermined work; and after executing the waypoint following control, a work time following control which controls the arm to place the component or the tool at the work start position and which controls the arm to perform a work time following in which the component or the tool follows the object which is being moved.

A third aspect of the present invention is a work robot system including an object conveying device for conveying an object; a robot having an arm; and a controller configured to control the arm to perform a predetermined work on a target portion of the object which is being moved by the object conveying device, wherein the controller is configured to perform: a waypoint following control which controls the arm so that a component or a tool supported by a distal end portion of the arm follows the object, which is being moved, at each of one or more waypoints before moving the component or the tool to a work start position of the predetermined work; and after executing the waypoint following control, a work time following control which controls the arm to place the component or the tool at the work start position and which controls the arm to perform a work time following in which the component or the tool follows the object which is being moved.

### BRIEF DESCRIPTION OF DRAWINGS

FIG. 1 is a schematic plan view of a work robot system according to a first embodiment.

FIG. 2 is a schematic side view of the work robot system according to the first embodiment.

FIG. 3 is an example of image data obtained by a sensor of the work robot system of the first embodiment.

FIG. 4 is a block diagram of a control device of the work robot system according to the first embodiment.

FIG. 5 is a flowchart of an example of processing performed by the control device of the work robot system according to the first embodiment.

FIG. 6 is an example of a displayed screen of a display device of the work robot system according to the first embodiment.

FIG. 7 is a flowchart of an example of the processing performed by the control device of the work robot system according to the first embodiment.

FIG. 8 is a schematic plan view of the work robot system according to the first embodiment.

FIG. 9 is an example of a displayed screen of the display device of the work robot system according to the first embodiment.

FIG. 10 is a schematic plan view of a work robot system according to a second embodiment.

FIG. 11 is a schematic side view of a work robot system according to a third embodiment.

FIG. 12 is a schematic plan view of the work robot system according to the third embodiment.

FIG. 13 is an example of a displayed screen of a display device of the work robot system according to the third embodiment.

FIG. 14 is a flowchart of an example of processing performed by a control device of the work robot system according to the third embodiment.

### DESCRIPTION OF EMBODIMENTS

A robot performing work on an object which is being moved by a conveying device or the like is important for improving the efficiency of the system. At this time, depending on the kind of the object, it may be preferable not to move the component of the distal end portion of the robot in a straight line toward the work start position. Or, depending on the type of the object or the like, there may be a case where the component or the like at the distal end portion of the robot cannot be moved linearly toward the work start position. For example, there may be a case where the linear movement of a component or the like may cause contact with the object. Thus, there is a need for a robot, a controller for the robot, and a work robot system that can avoid contact with the component or a tool supported by the robot and the object as much as possible.

A work robot system 1 according to a first embodiment will be described with reference to the drawings.

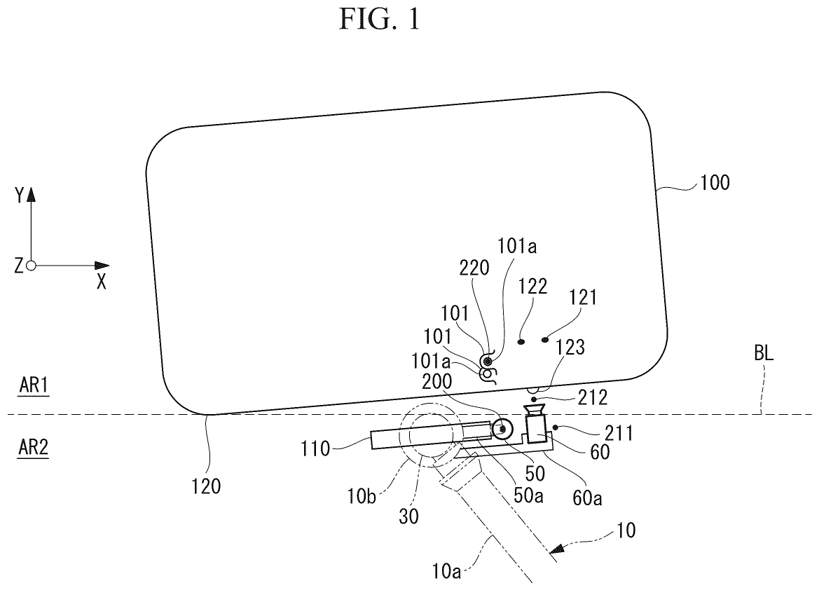

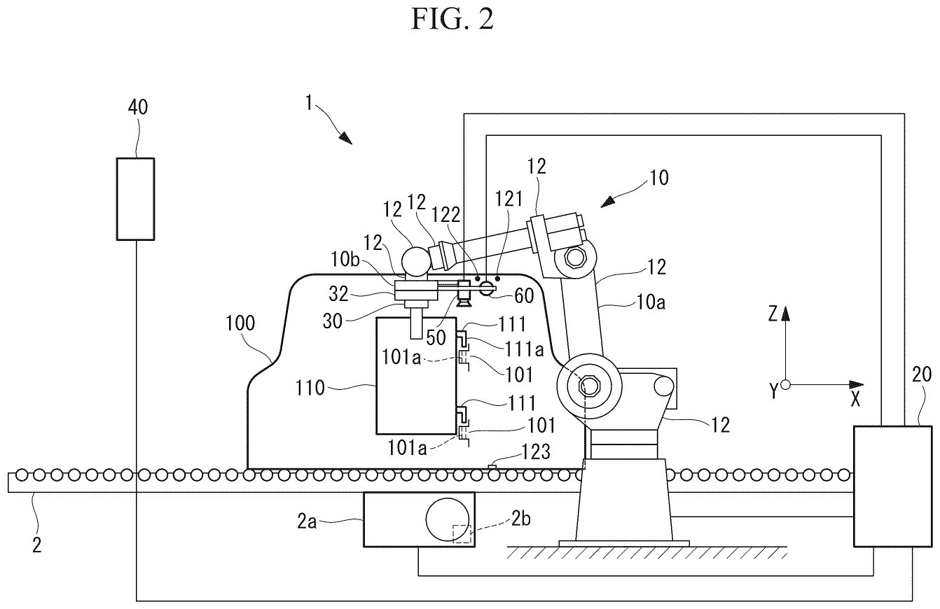

As shown in FIGS. 1 and 2, the work robot system 1 includes a conveying device (object moving device) 2 for conveying an object 100 which is a work target. The work robot system 1 includes a robot 10, a control device (controller) 20 for controlling the robot 10, and a detection device 40. The robot 10 performs a predetermined work on a target portion 101 of the object 100 moved by the conveying device 2. The work robot system 1 also has a first following sensor 50 and a second following sensor 60 mounted on the distal end portion of the robot 10.

The detection device 40 acquires data that can identify at least a position of the object 100 conveyed by the conveying device 2 and its target portion 101. The detection device 40 may acquire data that can identify the position and orientation of the target portion 101. In this embodiment, the target portion 101 has a plurality of holes 101a. A function of the detection device 40 may be performed by the following sensors 50, 60.

It is possible to employ any device having such a function as the detection device 40. For example, the detection device 40 can be a two-dimensional camera, a three-dimensional camera, a three-dimensional distance sensor, a sensor that irradiates a line beam to the work target to measure its shape, a photoelectric sensor, and the like. The detection device 40 in the first embodiment has a function that is same as or similar to the following sensors 50, 60. The detection device 40 in the first embodiment is a two-dimensional camera provided along a conveyance route of the conveying device 2. The detection device 40 acquires image data of the target portion 101 in a state where the target portion 101 is positioned in a predetermined area of an angle of view, and the detection device 40 sends the image data to the control device 20 as an output. The detection device 40 may be a camera or a sensor that faces a downward direction or a camera or a sensor that faces a diagonally downward direction or a horizontal direction, and the like.

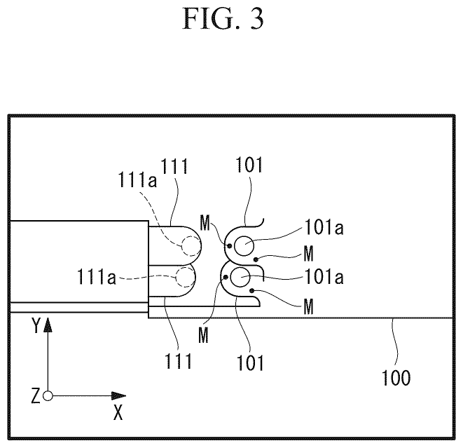

The image data is data that can identify a position of at least one of the plurality of target portions 101. There is a case where the control device 20 identifies the position of the target portion 101 based on a position, shape, and the like of a feature part of the object in the image data. Also, the control device 20 can identify the orientation of the target portion 101 based on a position relation of the plurality of the target portions 101 in the image data as well. The detection device 20 can identify the orientation of the target portion 101 based on the position, shape, and the like of the feature part in the image data. The feature part may be an element with a feature such as a mark M shown in FIG. 3, a corner portion of the object 100, and the like.

Although the object 100 is not limited to a particular type, the object 100 of the first embodiment is a body of a vehicle as an example. The conveying device 2 is to move the object 100 in one direction by driving a motor 2a, the conveying device 2 in the first embodiment moves the object 100 toward the right side in FIG. 2. The motor 2a includes an operating-position detection device 2b, and the operating-position detection device 2b detects, in sequence, a rotation position and a rotation amount of an output shaft of the motor 2a. An example of the operating-position detection device 2b is an encoder. The detection value detected by the operating-position detection device 2b is sent to the control device 20. The conveying device 2 may include another structure for moving the object 100, such as a belt and the like, for example.

It is also possible to apply the above described configuration to a work robot system 1 which performs other operations such as processing, assembly, inspection, observation, and the like on the object 100. The object 100 can be any object as long as it is movable by some sort of a conveying means, and it is also possible to use any robot other than the robot 10 as an object moving device. When the object 100 is a vehicle body or a frame of a vehicle, the vehicle body or the frame may be conveyed by an engine, a motor, a wheel, and the like provided in the vehicle or the frame. In this case, the engine, the motor, the wheel, and the like operate as the object moving device. An AGV (Auto Guided Vehicle) and the like that is as the object moving device may convey the object 100. Also, the control device 20 may receive the moving route data from the control device of the other robot, the vehicle, the AGV, a sensor provided on them, and the like. Or, the control device 20 may calculate the moving route data of the object 100 or the target portion 101 by using the image data that is acquired in sequence by the detection device 40, the following sensors 50, 60, and the like.

The target portion 101 of the object 100 is a portion on which an arm 10a of the robot 10 performs the predetermined work. In the first embodiment, the predetermined work refers to a work in which the arm 10a lifts a component 110 by using a tool 30, and the arm 10a attaches an attaching portion 111 of the component 110 to the target portion 101. By doing so, for example, a plurality of shafts 111a extending downwardly from the attaching portion 111 of the component 110 are fitted into a plurality of holes 101a provided in the target portions 101 of the object 100. In the first embodiment, the arm 10a of the robot 10 attaches the attaching portion 111 of the component 110 to the target portion 101 in the state in which the object 100 is being moved in one direction by the

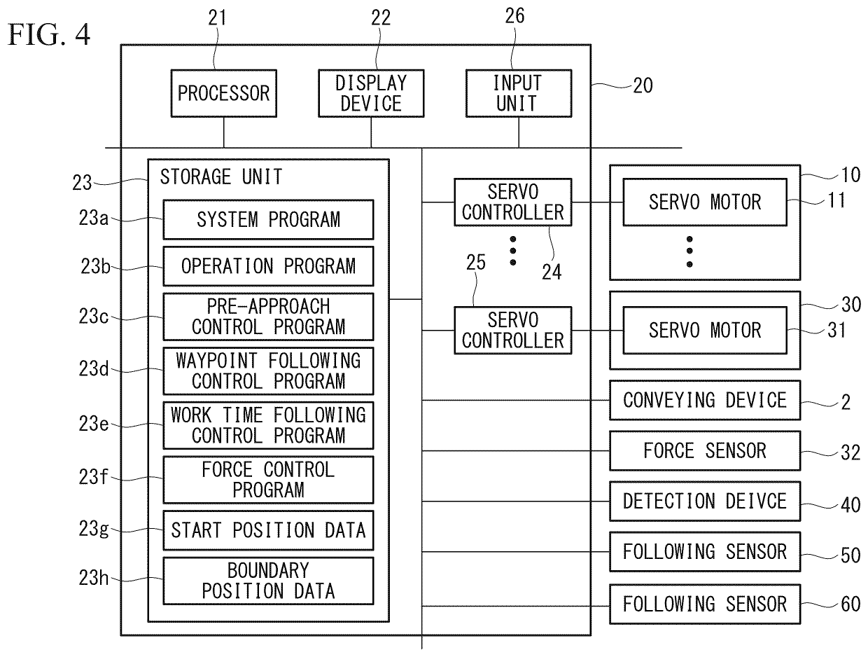

Although the robot 10 is not limited to a particular type, the robot 10 of the first embodiment is an articulated robot having six axes. The arm 10a of the robot 10 includes a plurality of servo motors 11 that respectively drive a plurality of movable portions 12 (see FIGS. 2 and 4). Each of the servo motors 11 has an operating-position detection device for detecting its operating position, and an example of the operating-position detection device is an encoder. The control device 20 receives the detection values of the operating-position detection device.

The tool 30 for moving the component 110 is attached to a distal end portion of the robot 10, and the tool 30 is used so as to move the component 110.

In one example, the tool 30 is a hand, and the tool 30 includes a servo motor 31 that drives the claws (see FIG. 4). The servo motor 31 has an operating-position detection device for detecting its operating position, and an example of the operating-position detection device is an encoder. The detection value detected by the operating-position detection device is sent to the control device 20. As the individual servo motors 11 and 31, various types of servo motors, such as rotary motors and linear motors, can be employed.

The robot 10 has a force sensor 32 at its distal end portion. The force sensor 32 detects forces for example, in an X-axis direction, a Y-axis direction, and a Z-axis direction, which are shown in FIGS. 1 to 3. The force sensor 32 detects forces around the X axis, around the Y axis, and around the Z axis as well. As the force sensor 32, a sensor that is capable of detecting the direction of the force and the magnitude of the force acting on the tool 30 or the component 110 gripped by the tool 30 can be used. The force sensor 32 is provided between the robot 10 and the tool 30 in the first embodiment. Alternatively, the force sensor 32 may be provided inside the tool 30, a base end portion of the arm 10a, another portion of the arm 10a, a base of the robot 10, and the like.

The following sensors 50, 60 are attached to the distal end portion of the arm 10a. In one example, the following sensors 50, 60 are attached to a wrist flange 10b of the arm 10a as well as the tool 30. The following sensors 50, 60 are a two-dimensional camera, a three-dimensional camera, a three-dimensional distance sensor, and the like. Each of the following sensors 50, 60 in the first embodiment is a two-dimensional camera.

In the first embodiment, the first following sensor 50 is a sensor which acquires, in sequence, image data of the target portion 101 as shown in FIG. 3 in a state in which the target portion 101 is positioned in a predetermined area of the angle of view. The following sensors 50, 60 can acquire, in sequence, image data in a state where waypoint following targets 121, 122, 123, which are shown in FIG. 1, are in a predetermined area of the angle of view. The following sensors 50, 60 send, in sequence, the image data (output) to the control device 20. The image data is data that can identify at least the position of the target portion 101 and the waypoint following targets 121, 122, 123 conveyed by the conveying device 2. The following sensors 50, 60 may acquire data that can identify the position and the orientation of the target portion 101 and the waypoint following targets 121, 122, 123.

The image data is data that can identify the position of at least one of the plurality of the target portions 101 when there is a plurality of the target portions 101. There may be a case where the control device 20 identifies the position of the waypoint following targets 121, 122, 123 and the like based on a position, shape, and the like of the feature part of the object in the image data. Also, the control device 20 can identify the orientation of the target portion 101, the waypoint following target 121, and the like based on a position relation of the plurality of the target portions 101, the plurality of the waypoint following targets 121, and the like in the image data. The feature part may be an element with a feature such as the mark M shown in FIG. 3, the corner portion of the object 100, and the like.

The position and orientation of a coordinate system of the following sensors 50, 60 and the position and orientation of a coordinate system of the robot 10 are associated with each other in advance in the control device 20. In one example, a coordinate system of either of the following sensors 50, 60 is set to be a reference coordinate system of the robot 10 that operates according to an operation program 23b. It is possible to associate a coordinate system that has a tool center point (TCP) of the tool 30 as its origin with the reference coordinate system or associate a coordinate system having a reference position of the component 110 as its origin with the reference coordinate system, and the like.

As shown in FIG. 4, the control device 20 includes a processor 21 having a processor element or plurality of processor elements such as a CPU, a microcomputer, and the like, and a display device 22. The control device 20 includes a storage unit 23 having a non-volatile storage, a ROM, a RAM, and the like. The control device 20 includes a plurality of servo controllers 24 that respectively correspond to the servo motors 11 of the robot 10, and a servo controller 25 that corresponds to the servo motor 31 of the tool 30. The control device 20 also includes an input unit 26 that is connected to the control device 20 in a wired or wireless manner. In another example, the input unit 26 is an input device such as an operation panel and the like that can be carried by a user. Another example is a tablet computer. In such a case where the input unit 26 is the tablet computer, input is made by using a touch screen function. There is also a case in which the operation panel or the tablet computer has the display device 22.

The storage unit 23 stores a system program 23a, and the basic functions of the control device 20 are performed by the system program 23a. In addition, the storage unit 23 stores an operation program 23b. The storage unit 23 additionally stores a pre-approach control program 23c, a waypoint following control program 23d, a work time following control program 23e, and a force control program 23f.

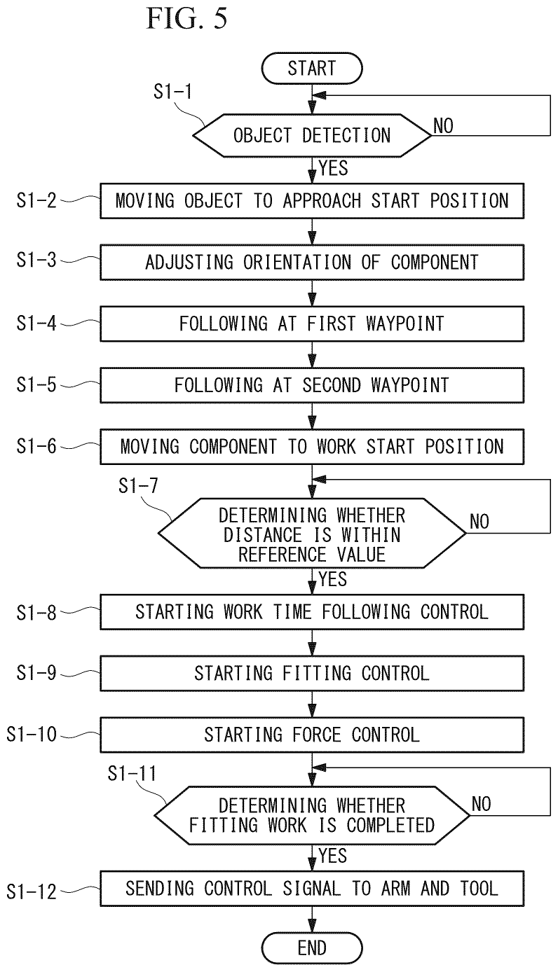

The control device 20 sends, on the basis of the aforementioned programs, control commands for performing the predetermined work on the object 100 to the respective servo controllers 24 and 25. Accordingly, the arm 10a and the tool 30 perform the predetermined work on the object 100. The operation of the control device 20 will be described with reference to the flowchart in FIG. 5.

First, the control device 20 detects the object 100 based on the output of the detection device 40 or the following sensors 50, 60 (step S1-1). After the detection, the control device 20 starts to send control commands based on the pre-approach control program 23c to the arm 10a and the tool 30 (step S1-2). By this, the arm 10a moves the tool 30 placed at a standby position to a position where the component 110 is placed, and the tool 30 grips the component 110. And, the arm 10a moves the component 110 to an approach start position 200 which is shown in FIG. 1.

In the first embodiment, as shown in FIG. 1, the approach start position 200 is a position closer to the base end portion of the robot 10 than a boundary line BL. Also, in the first embodiment, the approach start position 200 and waypoints described later are positions corresponding to the attaching portion 111 of the component 110. Alternatively, the approach start position 200 and the waypoints may be other positions of the component 110, positions corresponding to the distal end portion of the arm 10a, positions corresponding to predetermined positions of the tool 30, or the like.

Here, the positions and orientation of the objects 100 on the conveying device 2 may vary. The variation occurs, for example, when the objects 100 are placed on the conveying device 2. The variation is generated when each object 100 on the conveying device 2 moves slightly in an unintended direction due to vibration or the like. As shown in FIG. 1, there is also a case where the object 100 is placed on the conveying device 2 in a state where the object 100 is rotated around a vertical axis. At this time, the one end portion 120 of the object 100 in the X direction is disposed closer to the robot 10 than the target portion 101 in the Y direction.

The one end portion 120 can be said to be an interferable portion. In one example, the interferable portion is a portion close to the robot 10, the tool 30, and the component 110 in the Y direction. In FIG. 1, the rotation of the object 100 is illustrated in an exaggerated manner. There may be a case where the length of the object 100 is, for example, about 5 m, and the position of the object 100 in the rotation direction around the vertical axis varies within a range of about 2 degrees. In this case, the position of the one end portion 120 varies in the Y direction by 10 cm or more, and sometimes by 20 cm or more. If the variation of the mounting position in the Y direction is added to the variation, the variation in the position of the one end portion 120 in the Y direction becomes much larger.

In one example, the storage unit 23 of the control device 20 stores start position data 23g, which is the coordinate values of the component 110 at the approach start position 200 (FIG. 4). That is, as shown in FIG. 1, the arm 10a places the component 110 at the approach start position 200 which corresponds to the start position data 23g. Thus, even if the one end portion 120 is moved by the conveying device 2 until the one end portion 120 passes in front of the component 110, the component 110 does not interfere with the one end portion 120. In the first embodiment, the interference refers to the interference of the one end portion 120 with the component 110, the arm 10a, or the tool 30 while the one end portion 120 is passing in front of the component 110, as described above. The storage unit 23 of the control device 20 may store the start position data 23g, which is coordinate values of the tool 30 or coordinate values of the distal end portion of the arm 10a.

In another example, the storage unit 23 of the control device 20 stores the position information of the boundary line BL as boundary position data 23h (FIG. 4). The storage unit 23 of the control device 20 may store information of an area AR1 where interference may occur, information of an area AR2 where interference does not occur, and the like (FIG. 4). As shown in FIG. 1, the boundary line BL is a line dividing the area AR1 where the interference may occur and the area AR2 where the interference does not occur by the one end portion 120 moved by the conveying device 2.

The start position data 23g and/or the boundary position data 23h allow the arm 10a to be positioned at the approach start position 200 such that the component 110 does not come into contact with the object 100.

The storage unit 23 may store at least one of the start position data 23g and the boundary position data 23h. In one example, the control device 20 stores the start position data 23g and the boundary position data 23h in the storage unit 23 based on the input to the input unit 26 by the user. In another example, the control device 20 detects or calculates a path of the one end portion 120 which is being moved by the conveying device 2 using the image data of the detection device 40 or the following sensor 50.

In one example, the path corresponds to the boundary line BL. And, the control device 20 sets the start position data 23g and the boundary position data 23h based on the result of the detection or the calculation. The control device 20 may update the start position data 23g and the boundary position data 23h each time the next object 100 comes. For example, when the next object 100 to be worked on comes, the control device 20 detects the position of the one end portion 120 using the image data. Then, the control device 20 updates the start position data 23g or the boundary position data 23h by using the position or the position and moving route data of the conveying device 2. This update prevents the distance between the component 110 and the target portion 101 from becoming unnecessarily far at the approach start position 200. Moreover, the start position data 23g may be data indicating a predetermined area. In this case, the arm 10a moves the component 110 to any position within the predetermined area. The setting of the approach start position 200 may be replaced by a setting of a first waypoint 211 which will be described later.

The control device 20 adjusts the orientation of the component 110 at the approach start position 200 or the orientation of the component 110 moving toward the approach start position 200 in response to the orientation of the target portion 101 based on the pre-approach control program 23c (step S1-3). In one example, the control device 20 adjusts the orientation of the component 110 while conveying of the component 110 to the approach start position 200 or when the component 110 reaches the approach start position 200. For example, the control device 20 detects the orientation of the target portion 101 using the image data of the following sensors 50, 60, and adjusts the orientation of the component 110 to match the detected orientation. It is also possible to set the control device 20 not to execute the step S1-3.

The control device 20 causes the component 110 to follow the object 100 at the first waypoint 211 (FIG. 1) by the arm 10a based on the waypoint following control program 23d (step S1-4). The following at the second waypoint 212 is also performed based on the waypoint following control program 23d. In the first embodiment, the position of the component 110 corresponding to the attaching portion 111 follows the component 110. The waypoints 211, 212 are a relative position with respect to the object 100. A configuration may be used in which the distal end portion of the arm 10a, the tool 30, or the like follows the object 100 at the first waypoints 211, 212.

For the following control, the control device 20 performs visual feedback using the image data sequentially obtained by the following sensors 50, 60, for example. In another example, the controller 20 provides the visual feedback using data sequentially obtained by another camera, another sensor, and the like. The other camera and the other sensor may be supported on the distal end portion of other robot or may be fixed at a predetermined position. The other camera and the other sensor may be supported by a slider that is movable in a conveyance direction of the conveying device 2. Depending on the type, shape, and the like of the target portion 101, the following sensors 50, 60, the other camera, and the other sensor may be a three dimensional camera or a three dimensional distance sensor.

Known visual feedback may be used for the above described control. In the first embodiment, as the control of the visual feedback, for example, one of the following two types of control can be adopted. Note that, in the two types of control, the control device 20 detects at least the position of the waypoint following target 121, and causes the component 110 to follow the object 100 based on the detected position. The control of the control device 20 becomes similar to or the same in a case where the component 110 is caused to follow the object 100 based on the positions of the waypoint following targets 122, 123, the target portion 101, and the like.

The moving route of the object 100 conveyed by the conveying device 2 may not be a straight line. In addition, there is a case where the orientation of the object 100 on the conveying device 2 is gradually changed due to vibration or the like. In these cases, the control device 20 can cause the orientation of the component 110 to follow the orientation of the target portion 101 in step S1-4 and step S1-5 which is described later. In particular, it is useful to make the orientation of the component 110 follow the orientation of the target portion 101 in step S1-5 so that the arm 10a can smoothly perform the work on the target portion 101.

The first control is a control for causing the component 110 to follow the object 100 by arranging the target to be followed at a predetermined position within the angle of view of the following sensors 50, 60 at any time. The second control detects the position of the target to be followed of the object 100 in the coordinate system of the robot 10 (the position with respect to the robot 10). And, the second control corrects the operation program 23b using the detected position of the target to be followed, thereby causing the component 110 to follow the object 100. The following objects are the waypoint following targets 121, 122, 123, the target portion 101, and the like.

In the first control, the control device 20 detects a characteristic portion on the image data sequentially obtained by the following sensors 50, 60. The characteristic portions are the overall shape of the target portion 101, the hole 101a on the target portion 101, a mark M (FIG. 3) provided on the target portion 101, and the like. The overall shapes of the waypoint following targets 121, 122, 123 of the object 100 are also the characteristic portions.

The control device 20 always arranges the characteristic portion at a predetermined position in the image data, keeping the characteristic portion within a range of the reference shape and size. The control device 20 transmits control commands for this purpose to the servo controller 24. Thus, the control device 20 can cause the component 110 to follow the position and the orientation of the characteristic portion. When each of the following sensors 50, 60 is a three dimensional camera, a three dimensional distance sensor, or the like, the control device 20 always arranges the characteristic portion at a predetermined position in the three dimensional image data, keeping the characteristic portion in the reference orientation. That is, the control device 20 transmits the control commands for this purpose to the servo controller 24.

In the second control, the control device 20 detects an actual position of the characteristic portion with respect to the coordinate system of the robot 10 using the image data sequentially obtained by the following sensors 50, 60 or the like. The control device 20 corrects a teaching point of the operation program 23b based on the difference between the position of the characteristic portion assumed in the operation program 23b and the actual position of the characteristic portion.

In one example, the control device 20 always arranges the position of the first waypoint following target 121 obtained by using the second following sensor 60 at a predetermined position on the image data in order to execute the step S1-4. Thus, the control device 20 causes the component 110 to follow the object 100 at the first waypoint 211. When step S1-4 is started, for example, in FIG. 1, the position of the shaft 111a (relative position to the object 100) moves from the approach start position 200 to the first waypoint 211.

Subsequently, the control device 20 causes the component 110 to follow the object 100 at the second waypoint 212 by the arm 10a (step S1-5). In order to execute step S1-5, the control device 20 always arranges the position of the second waypoint following target 122 obtained by using the second following sensor 60 at a predetermined position in the image data. Alternatively, in order to execute the step S1-5, the control device 20 always arranges the position of the third waypoint following target 123 obtained by using the first following sensor 50 at a predetermined position on the image data. The control device 20 may cause the component 110 to follow both of the waypoint following targets 122, 123. The waypoint following control at each waypoint 211, 212 will be terminated when a degree of coincidence between the images sequentially obtained by the following sensors 50, 60 and a taught image exceeds a predetermined criteria. For example, when the coincidence degree exceeds a predetermined criteria at the first waypoint 211, the control device 20 terminates the following control at the first waypoint 211. Then, the control device 20 shifts the control to the operation for the following control at the second waypoint 122. In one example, the time period during which the waypoint following control is performed at each waypoint 211, 212 is 0.1 to several seconds. There may be a case where the waypoint following is performed within a time shorter than the above-mentioned time. It is possible to set any time, any distance, and the like for performing the waypoint following control at each waypoint 211, 212.

Subsequently, the control device 20 moves the shaft 111a of the component 110 to the work start position 220 with respect to the target portion 101 based on the work time following control program 23e (step S1-6). The control device 20 executes step S1-5 using the visual feedback and the image data of the following sensors 50, 60. In another example, in step S1-6, the control device 20 moves the component 110 by a predetermined distance toward the target portion 101 by the arm 10a. In step S1-6, the control device 20 may bring the component 110 close to the target portion 101 by the arm 10a using data of the other camera or the other sensor. At this time, the control device 20 may cause the orientation of the component 110 approaching the target portion 101 to follow the orientation of the target portion 101 by the visual feedback.

By controlling the arm 10a in step S1-6, the component 110 reaches the position and the orientation to be fitted into the target portion 101. As a result, the target portion 101 exists within a certain area of the angle of view of the first following sensor 50. When the distance between the attaching portion 111 and the target portion 101 becomes within the reference value (step S1-7), the control device 20 starts the work time following control (step S1-8). The control device 20 also starts the fitting control for fitting the attaching portion 111 to the target portion 101 based on the operation program 23b (Step S1-9).

The control device 20 executes step S1-8 by causing the component 110 to follow the target portion 101 based on the work-time following control program 23e. Further, when the detection results of the second following sensor 60, the other camera, or the other sensor are also used, the determination in step S1-7 becomes more accurate.

Preferably, the control device 20 uses a characteristic portion that is visible from the following sensor 50 when the fitting is performed for the work-time following control in step S1-8. Alternatively, the control device 20 can change the characteristic portion used for the following control when the characteristic portion used for the following control becomes invisible from the following sensors 50, 60.

In the state where the control is performed in this manner, the control device 20 starts force control based on the force control program 23f (step S1-10). A known force control may be used in step S1-10. In the first embodiment, the arm 10a moves the component 110 in a direction away from the force detected by the force sensor 32 based on the control by the control device 20. The controller 20 determines the amount of movement in accordance with the detected value of the force sensor 32.

For example, after starting the fitting control, the force sensor 32 may detect a force in a direction opposite to the moving direction of the conveying device 2. At this time, the control device 20 moves the component 110 in a direction opposite to a moving direction by the conveying device 2 in accordance with the detected value of the force sensor 32 while performing the work-time following control. And, when the force sensor 32 detects a force equal to or greater than the reference value, the control device 20 performs an abnormality response operation.

On the other hand, the control device 20 determines whether or not the fitting work is completed (step S1-11), and sends control commands to the arm 10a and the tool 30 in the case in which the fitting work is completed (step S1-12). This causes the tool 30 to move away from the component 110, and causes the arm 10a to move the tool 30 to the standby position or to a location where a subsequent component 110 is

In the first embodiment, the position of the attaching portion 111 passes through the first waypoint 211 and the second waypoint 212 between the approach start position 200 and the work start position 220. Also, the position of the attaching portion 111 follows the object 100 which is being conveyed by the conveying device 2 at the first waypoint 211 and the second waypoint 212. If the first waypoint 211 and the second waypoint 212 are not set, the position of the attaching portion 111 is moved from the approach start position 200 to the work start position 220 along a straight line, for example. In the case where there is a possibility that the component 110 and the object 100 may come into contact with each other in the linear movement, the first embodiment capable of setting the following control at the waypoints 211, 212 is useful.

When using two following sensors 50, 60, even if these sensors are two dimensional sensors, the movement of the object 100 in the X, Y, and Z directions can be followed.

There is a case where conveyance speed of the conveying device 2 changes under a certain condition. Also, the position of the object 100 relative to the detection device 40 when the object 100 is detected by the detection device 40 may not be completely constant. The latter is affected by a cycle time or the like with which the control device 20 performs the image processing of the detection device 40. In these cases, the setting for executing the linear movement after a certain time from the detection by the detection device 40 may cause the contact between the component 110 and the object 100. Even in this situation, the setting for executing the following at the waypoints 211, 212 is useful.

Also, there may be a case in which the following sensor 60 is not provided and a single following sensor 50 is provided. In this case also, as described above, the position of the shaft 111a can be made to follow the object 100 which is being conveyed at the first waypoint 211 and the second waypoint 212.

A setting method for the following at the waypoints 211, 212 and a configuration for the setting will be described below. The user makes the setting by input to the input unit 26, for example. The input unit 26 is an operation panel, a tablet computer, a remote controller with a joystick, or the like, and the input is performed using a touch screen function, a joystick, or the like.

The input unit 26 has a display device 22 capable of displaying a plurality of types of displayed screens for teaching the operation of the arm 10a. One of the types of displayed screens is a teaching screen for setting a moving route of the distal end portion of the arm 10a, a predetermined position of the tool 30, and the like. An example of the teaching screen is a known teaching screen in which the user teaches a plurality of teaching points. The user may teach the plurality of teaching points by inputting coordinate values. The user may teach the plurality of teaching points by moving the distal end portion of the arm 10a to a plurality of arbitrary positions and performing a predetermined input to the input unit 26. The method of moving the arm 10a in this case is a known method such as an operation of the joystick, an operation of the operation panel, an operation of moving the distal end portion of the arm 10a by applying a force by the user, and the like.

In the first embodiment, for example, the standby position, the position where the component 110 is placed, the approach start position 200, and the like are taught as the teaching points.

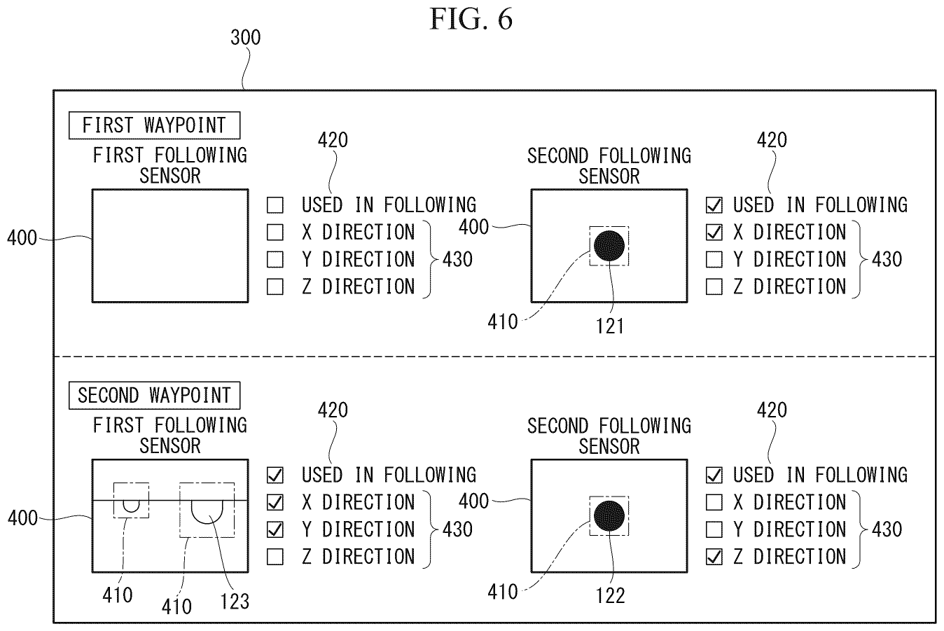

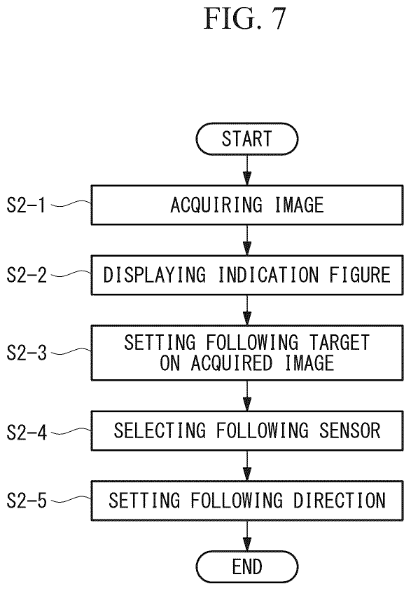

At least one other of the plurality of types of displayed screens is a waypoint teaching screen 300 (FIG. 6) for teaching the following at the waypoints 211, 212. In the waypoint teaching screen 300 illustrated in FIG. 6, the user teaches following targets at the respective waypoints 211, 212. An example of the process by the control device 20 for teaching the following target will be described below with reference to FIG. 7. Typically, the user performs the following teaching using the object 100 on the stopped conveying device 2 in a stationary manner. On the other hand, there is a case where the teaching can be performed even in a state where the object 100 is being moved by the conveying device 2.

For example, the user places the distal end portion of the arm 10a at an arbitrary position and orientation, and in this state, the user makes a first input to the input unit 26 so as to set the waypoint. In response to the first input, the control device 20 causes each of the following sensors 50, 60 to acquire the images at the position and the orientation (step S2-1). Thereafter, the user makes a second input to the input unit 26 so as to set the waypoint. In response to the second input, the control device 20 determines the following target on the acquired image (step S2-3).

The user actually places the arm 10a, the tool 30, the component 110, and the like with respect to the object 100, and the control device 20 sets the following target based on an image acquired at the position. This configuration is useful for realizing prevention of contact, improving work efficiency, and the like. The control device 20 may set the first waypoint 211 as the approach start position 200.

Before making the second input, the control device 20 displays a single or a plurality of indication FIG. 410 on an acquired image 400 shown in FIG. 6 (step S2-2). The acquired image 400 may be an enlarged image of a part of the image obtained by the following sensors 50, 60 as shown in FIG. 6. Each of the indication FIG. 410 is for indicating a portion that can be set as the following object on the acquired image 400, for indicating a characteristic shape on the acquired image 400, or the like. Instead of the indication FIG. 410 shown in FIG. 6, an indication figure that makes the outer edge, the inside, or the like of the characteristic shape stand out may be shown. In the specification in which a cursor is used to highlight the characteristic shape, the cursor also functions as the indication figure.

The user moves the indication FIG. 410, changes the size of the indication FIG. 410, and the like as a part of the second input. Alternatively, the user may select any one or more of the plurality of indication FIG. 410 as the second input. The characteristic shapes set by the second input become the waypoint following objects 121, 122, 123 or the like. Note that, when the control device 20 automatically sets the characteristic shape in the acquired image 400 as the waypoint following target, the control device 20 does not perform the above described processing in response to the second input.

Thereafter, the user makes a third input to the input unit 26 so as to set the waypoint. In response to the third input, the control device 20 sets the following sensors 50, 60 to be used at each of the waypoints 211, 212. The waypoint teaching screen 300 has a sensor selection indication 420 for selecting or displaying whether or not the following sensors 50, 60 are used to follow the waypoints 211, 212. The control device 20 sets a following sensor selected by the third input as the following sensor to be used for the waypoint following sensor (step S2-4). In the first embodiment, the user makes a third input using a check box which belongs to the sensor selection indication 420. Note that, in such a case in which the following sensor to be used for the following is predetermined, a case in which only a single following sensor 50 is provided, and the like, the control device 20 does not perform the above described processing in response to the third input.

Also, the user makes a fourth input to the input unit 26 so as to set the waypoint. In response to the fourth input, the control device 20 sets the following direction for following the waypoint at the waypoints 211, 212 (step S2-5). More specifically, the control device 20 sets the following direction based on the input made to the input unit 26. The waypoint teaching screen 300 has a direction selection indication 430 for setting the following direction at the waypoints 211, 212 for each of the plurality of following sensors 50, 60. The control device 20 sets the direction selected by the fourth input as the following direction at the waypoints 211, 212. Note that, when the following direction is predetermined, when the control device 20 automatically sets the following direction, and the like, the control device 20 does not perform the above described processing in response to the fourth input.

With the above configuration, the user can set whether to use the following sensors 50, 60 or not, and easily set the following direction. The user can also perform a test operation of moving the arm 10a by the following control each time the setting of the direction selection indication 430 is changed. This configuration is useful for realizing prevention of contact, improving work efficiency, and the like.

FIG. 6 shows that the following control is performed only in the X direction with respect to the first waypoint by using the image of the second following sensor 60. With respect to the second waypoint 122, FIG. 6 also shows that the image of the first following sensor 50 is used for the following control in the X and Y directions, and the image of the second following sensor 60 is used for the following control in the Z direction.

The above described configuration of the first embodiment provides a useful help in teaching the waypoint following control for performing the following control at the waypoints 211, 212. The above configuration that allows the selection of the following sensors 50, 60 at the waypoints 211, 212 provides a useful help in accurately performing the following control, the robot operation, and the like at the waypoints 211, 212. The above described configuration that enables setting of the direction of the following sensors 50, 60 in the waypoints 211, 212 can also provides a useful help in accurately performing the following control, the robot operation, and the like at the waypoints 211, 212.

The waypoint teaching screen 300 displays the setting state of the following target as described above. This configuration is useful for the user to accurately and easily recognize the presence or absence of the setting of the waypoints, the state of the setting of the waypoint, and the like.

One of the plural types of displayed screens is a work teaching screen for teaching the work time following at the work start position 220. As the work teaching screen, a known teaching screen for causing the shaft 110a of the component 111 to follow the target portion 101 by the visual feedback can be used. For example, the user places the arm 10a at the work start position 220, and the control device 20 causes the first following sensor 50 to acquire the images of the target portion 101 at the position. In one example, the images are acquired when the user makes a predetermined input to the input unit 26. The control device 20 sets the characteristic shape in the acquired image as the target object, and the control device 20 performs the above described following control during work by using the target object.

When the arm 10a is moved to the waypoints 211, 212, the control device 20 may move the distal end portion of the arm 10a in a predetermined direction based on the operation program 23b. In FIG. 1, when the component 110 is moved from the waypoint 211 to the waypoint 212, the control device 20 may move the component 110 in the Y direction based on the operation program 23b. At this time, the user can cancel the designation of the Y direction on the direction selection indication 430 of the first following sensor 50 with respect to the second waypoint on the waypoint teaching screen 300 of FIG. 6. With this setting, the control device 20 does not allow the component 110 to follow the object 100 in the Y direction at the second waypoint. If the direction of the operation control by the control commands of the operation program 23b and the direction of the following control are coincident with each other, the operation of the arm 10a may not be smooth due to overshoot or the like. The above structure is useful for reducing or eliminating the above problem.

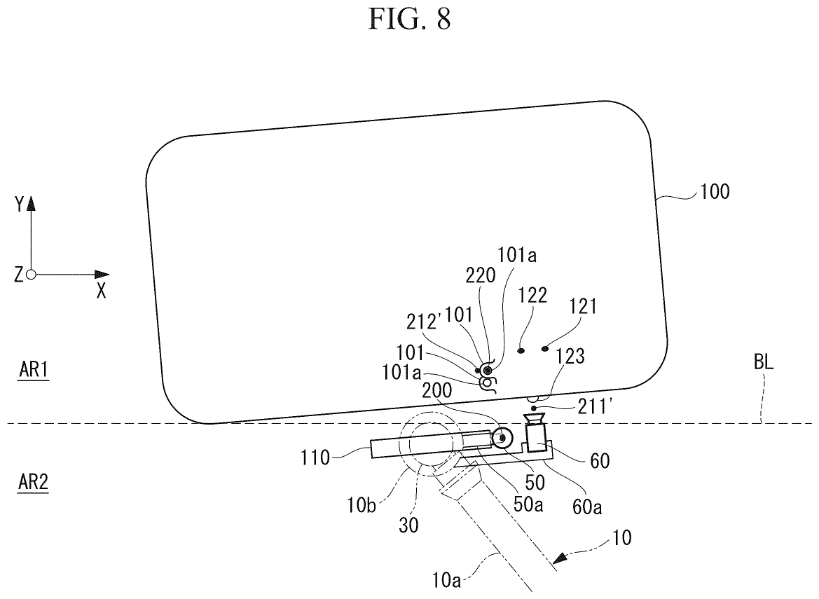

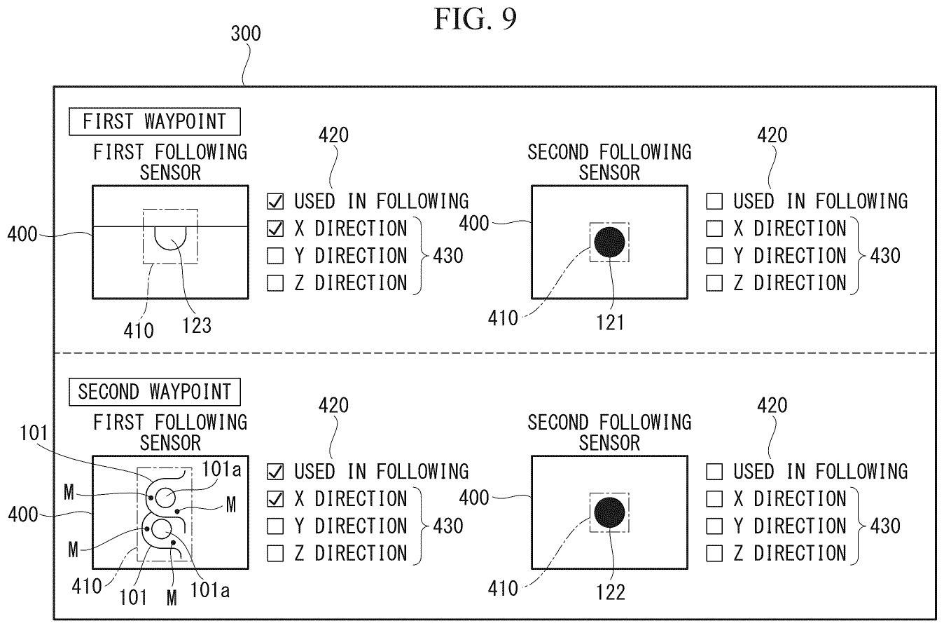

FIGS. 8 and 9 show a case in which the waypoints 211′, 212′, which are different from those in FIG. 1, are used to pass. In the example of FIG. 9, the following is not performed in the Z direction at the waypoints 211′, 212′. When the approach start position 200 is higher than the work start position 220, the positions of the waypoints 211′, 212′ in the Z direction are also higher than the work start position 220. In FIG. 8, positions of the second waypoint 212′ in the X direction and the Y direction are slightly shifted from those of the work start position 220, but they may be coincident with each other. In this case, the target to be followed at the work start position 220 can be used as the following target at the second waypoint 212′. This configuration is useful for reducing the teaching work by the user.

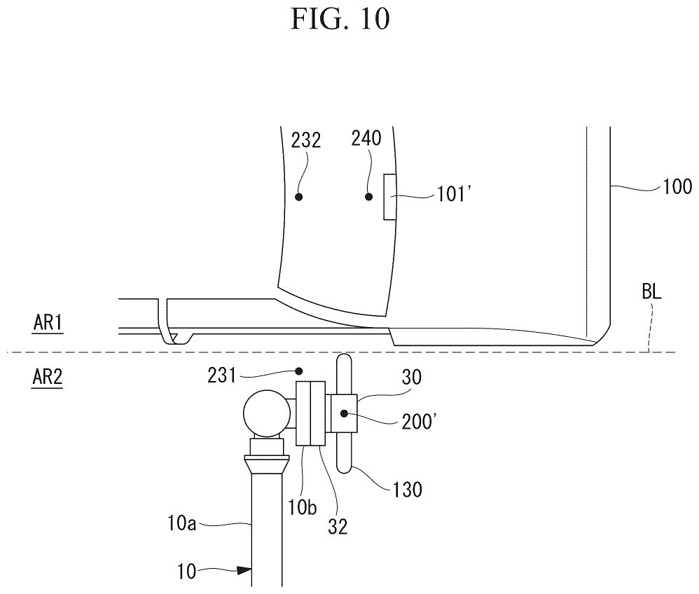

A work robot system according to a second embodiment will be described with reference to FIG. 10. In the second embodiment, a component 130 gripped by the tool 30 is a steering wheel, and a target portion 101′ is a mounting portion of the steering wheel. In the second embodiment, the same reference numerals are given to the components which are the same as similar to those of the first embodiment, and the description of the components and the effects, which are the same as or similar to those of the first embodiment, obtained by the components will be omitted.

In the case of the second embodiment, at least one of a plurality of waypoints 231, 232 is set inside the object 100. In the second embodiment, the center portion of the component 130 is the attaching portion attached to the target portion 101′, and the center portion of the component 130 follows the component 110 at the waypoints 231, 232 and a work start position 240.

For example, the first waypoint 231 is set outside the object 100, and the second waypoint 232 is set inside the object 100. A shift knob or the like can be used as a following target of the second waypoint 232.

In the second embodiment, when the component 130 is linearly moved from an approach start position 200′ to a work start position 240, the component 130 is always brought into contact with the object 100. Even in such a case, the second embodiment having the same configuration as the first embodiment can perform the setting for attaching the component 130 without contact without difficulty.

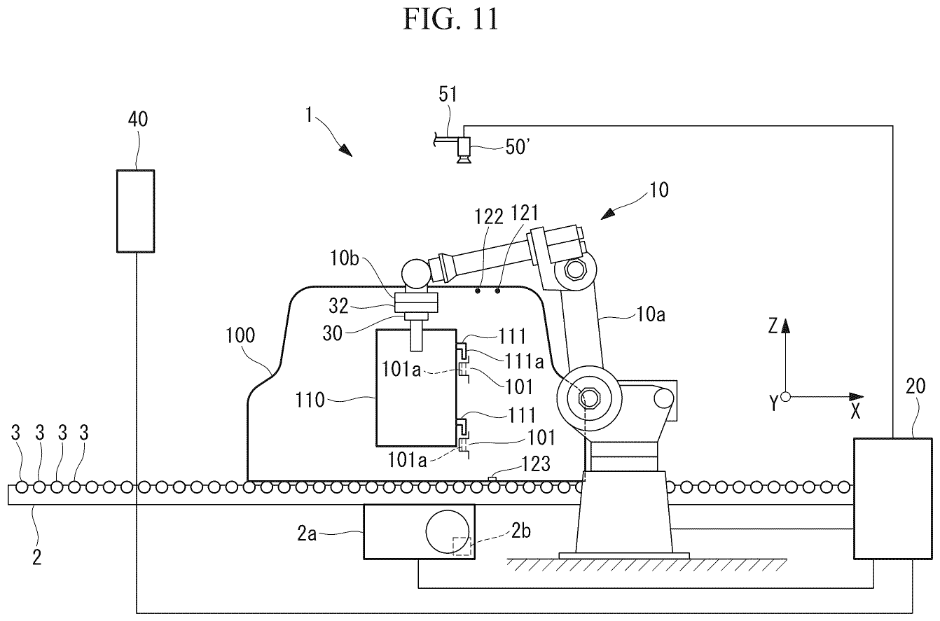

A work robot system according to a third embodiment will be described with reference to FIGS. 11 to 14. The third embodiment uses a first following sensor 50′ fixed at a predetermined position instead of the following sensors 50, 60 of the first embodiment. In the present embodiment, the following sensor 50′ is supported by a known frame 51 or the like.

The position of the following sensor 50′, its supporting structure, and the like are arbitrary. In the present embodiment, an arrangement position of the following sensor 50′ is located above the object 100. The following sensor 50′ may be supported by another robot, or the following sensor 50′ may be supported by a known linear guide movable in the conveying direction of the conveying device 2. The following sensor 50′ may be supported by other means. In the second embodiment, the same reference numerals are given to the components which are the same as or similar to those of the first embodiment, and the description of the components and the effects, which are the same as or similar to those in the first embodiment, obtained by the components will be omitted.

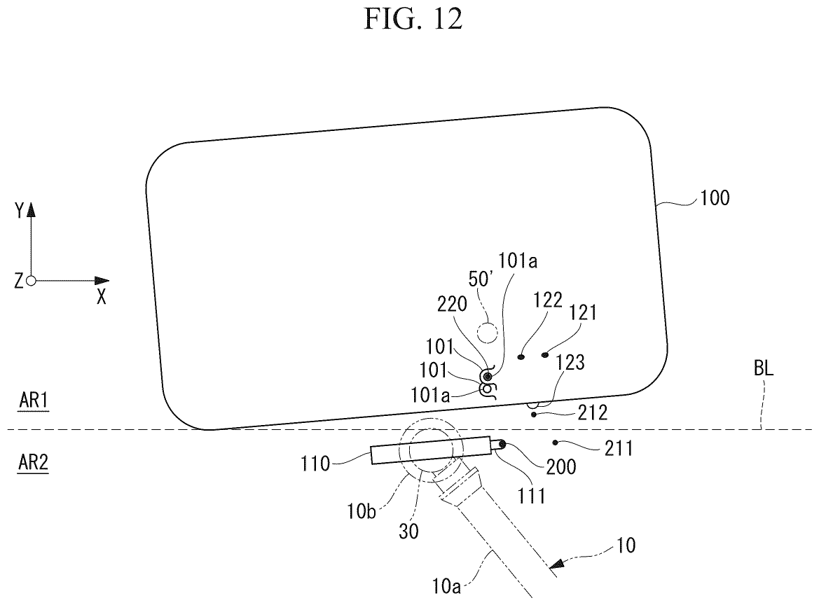

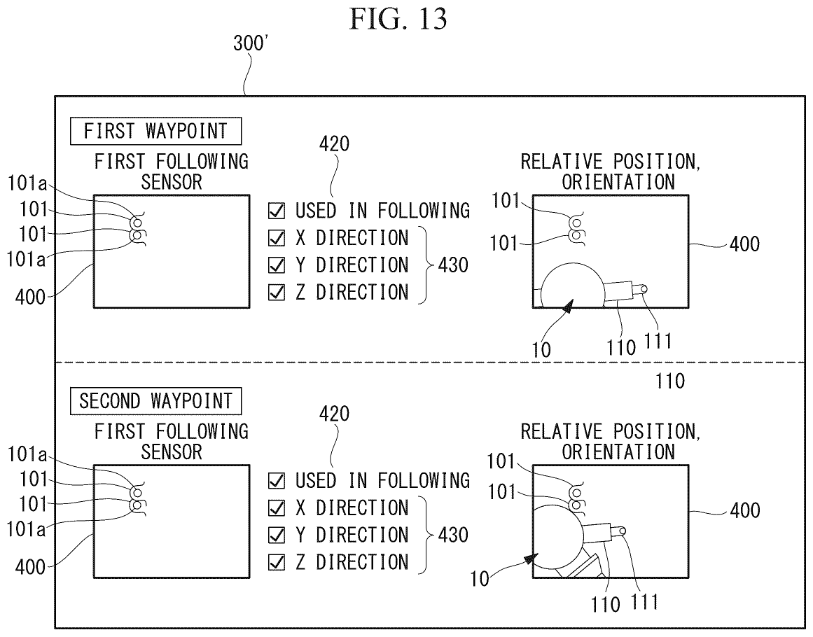

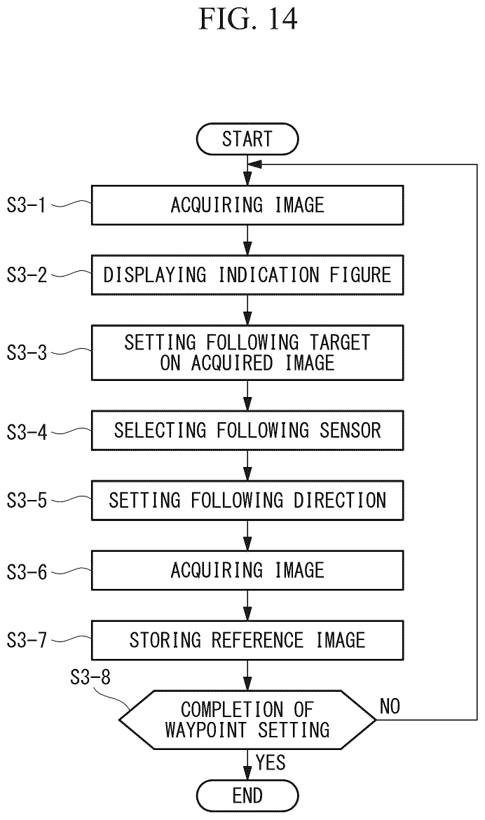

As the following sensor 50′, for example, a three dimensional camera, a three dimensional distance sensor, or the like is used. The position and direction of the coordinate system of the following sensor 50′ and the position and direction of the coordinate system of the robot 10 are associated in advance in the control device 20. In the third embodiment, the standby position, the position where the component 110 is placed, the approach start position 200, and the like are taught as the teaching points, for example. A waypoint teaching screen 300′ of the third embodiment may be slightly different from that of the first embodiment as shown in FIG. 13. In the waypoint teaching screen 300′ illustrated in FIG. 13, the user teaches the following target to be followed at the waypoints 211, 212 (FIG. 12). An example of the processing of the control device 20 for teaching the following target will be described below with reference to FIG. 14.

The control device 20 uses the waypoint teaching screen 300′, a known sound generating device which is built-in in the control device 20, and the like to request the user to teach the following target. The user places the distal end portion of the arm 10a at an arbitrary position and orientation, and in this state, the user makes a first input to the input unit 26 so as to set the waypoint. In response to the first input, the control device 20 causes the following sensor 50′ to acquire an image at the position and the orientation (step S3-1).

The control device 20 displays a single or a plurality of indication FIG. 410 on the acquired image 400 shown in FIG. 13 in the same manner as in the first embodiment (step S3-2). The user makes a second input to the input unit 26 so as to set the waypoint. In response to the second input, the control device 20 determines the following target on the acquired image (step S3-3). Although the following target at the first waypoint 211 in FIG. 13 is the target portion 101, another portion 123 of the object 100, or the like that is convenient for waypoint following may be set as the target to be followed.

Subsequently, the user makes the third input and the fourth input for setting the waypoint to the input unit 26 in the same manner as in the first embodiment, and performs the same processing as in the first embodiment (steps S3-4 and S3-5). In this embodiment, since there is only one following sensor, step S3-3 is not necessary, but step S3-3 is useful when there are two or more following sensors. Also, if more than two units of two-dimensional cameras facing the same directions as the following sensors 50, 60 are used instead of the following sensor 50′ to obtain three-dimensional images, three-dimensional detection will be possible by the two-dimensional cameras.

Subsequently, the control device 20 requests the user to teach a relative position and relative orientation of the following target and a portion to be followed, by using the waypoint teaching screen 300′, the sound generating device, and the like. The user places the distal end portion of the arm 10a at an arbitrary position and orientation corresponding to the first waypoint 211, and in this state, the user makes a fifth input to the input unit 26 so as to set the waypoint.

In response to the fifth input, the control device 20 causes the following sensor 50′ to acquire an image at the position and the orientation (step S3-6). The acquired image indicates the relative position between the following target and the portion of the component 110 to be followed. In the present embodiment, the component 110, the attaching portion 111 of the component 110, and the like are the parts to be followed. The control device 20 stores the acquired image in the storage unit 23 as a reference image (step S3-7).

Also, in step S3-1, the control device 20 also can require that both the following target and the portion to be followed are included in the acquired image. In this case, step S3-7 is performed without performing step S3-6.

The control device 20 repeats steps S3-1 to S3-6 until the above setting is performed for all the waypoints (step S3-8).

In the third embodiment, the control device 20 also performs the visual feedback using the image data sequentially obtained by the following sensors 50, 60, for example, for the purpose of following the waypoints 211, 212. Although known visual feedback can be used for the control, in the third embodiment, the control device 20 performs a following control which will be described below.

The control device 20 arranges the following target and the portion to be followed within the angle of view of the following sensor 50′ so that their relative position coincides with the reference image within a predetermined criteria. In addition, the control device 20 may arrange the following target and the portion to be followed within the angle of view so that their relative orientation also matches the reference image beyond a predetermined criteria. The visual feedback causes the attaching portion 111 of the component 110 to follow the target portion 101 of the object 100.

In the third embodiment, the control device 20 performs the waypoint following based on the relative position between the following target and the portion to be followed, which can be seen from the following sensor 50′ fixed at a part other than the arm 10a. In the angle of view of the following sensor mounted on the distal end portion of the arm 10a, the tool 30 or the like may interfere with the detection of the following target. The third embodiment has a high degree of freedom in the arrangement of the following sensor 50′, which contributes to the reduction of the above described detection disturbance.

Also, in the third embodiment, the waypoint teaching screen 300′ displays the settings of the following target and the portion to be followed. This configuration is useful for the user to accurately and easily recognize the presence or absence of the setting of the waypoints, the state of the setting of the waypoints, and the like.

There are situations where the linear movement of the component 110 from the approach start position 200 to the work start position may result in contact of the object 100 with the arm 10a, the tool 30, the component 110, and the like. Alternatively, as in the second embodiment, there is a situation in which the component 110 is always brought into contact with the object 100 when the component 110 is linearly moved from the approach start position 200 to the work start position. In the above embodiment, the arm 10a can cause the component 110 to perform the waypoint following at the plurality of waypoints before the arm 10a moves the component 110 to the work start position. With this configuration, the user can perform various settings for preventing the contact. Also, in some cases, the arm 10a causes the component 110 to perform the waypoint following at a single waypoint before the arm 10a moves the component 110 to the work start position. Even in this case, the effects of the each embodiment can be achieved.

Also, in the each of the above embodiment, the arm 10a causes the component 110 to follow the object 100, but the arm 10a may cause the tool 30 to follow the object 100 in the above embodiments. The configuration also provides the same effects as those of the above described embodiment. The tool 30 may perform various known operations such as welding, processing for assembly, applying a sealant to a part of the object 100, and the like as a predetermined operation.

Also, the control device 20 of the first embodiment may perform the waypoint following based on the relative position between the following target and the portion to be followed, as in the third embodiment. In this case, the reference image is stored in the storage unit 23 in the first embodiment.

While the embodiment of the present disclosure has been described in detail, the present disclosure is not limited to the individual embodiments described above. Various additions, substitutions, changes, partial deletions, and the like can be made to the embodiment within a range not departing from the gist of the invention, or within a range not departing from the concept and purport of the invention derived from the contents described in the claims and their equivalents. For example, in the above described embodiment, it is possible to change the order of operations, change the order of processing, omit or add a part of works according to conditions, and omit or add a part of processing according to conditions without being limited to the above described example. The same applies to the case where numerical values or mathematical expressions are used in the description of the above described embodiment.

1. A robot comprising:
an arm; and
a controller that controls the arm, wherein
the robot is configured to perform a predetermined work on a target portion of an object which is being moved by an object conveying device,
wherein the controller is configured to perform:
a waypoint following control which controls the arm so that a component or a tool supported by a distal end portion of the arm follows the object, which is being moved, at each of one or more waypoints before moving the component or the tool to a work start position of the predetermined work; and
after executing the waypoint following control, a work time following control which controls the arm to place the component or the tool at the work start position and which controls the arm to perform a work time following in which the component or the tool follows the object which is being moved.

2. The robot according to claim 1, wherein the controller is configured to perform the waypoint following control using visual feedback.

3. The robot according to claim 1, wherein
the controller is configured to perform the work time following control using visual feedback, and
a following target used for the work time following control is used for the following control at a waypoint which is the closest to the work start position among the one or more waypoints.

4. The robot according to claim 1, wherein
the controller stores an operation program that causes the arm to perform a predetermined operation, and
the controller is configured not to cause the component or the tool to follow the object in a predetermined direction when the following control is performed while moving the component or the tool in the predetermined direction by the operation program.

5. The robot according to claim 1 comprising:
a display device capable of displaying a waypoint teaching screen for a teaching of the following control at each of the one or more waypoints; and
an input unit for performing an input for the teaching of the following control.

6. The robot according to claim 5, wherein
the display device is capable of displaying a screen for designation of a following direction for each of the one or more waypoints, the following direction is a direction in which the following control is to be performed, and
the controller is configured to cause the arm to follow each of the waypoints in a direction corresponding to the designation.

7. A robot controller, wherein the robot controller is configured to control an arm of a robot that performs a predetermined work on a target portion of an object which is being moved by an object conveying device,
wherein the robot controller is configured to perform:
a waypoint following control which controls the arm so that a component or a tool supported by a distal end portion of the arm follows the object, which is being moved, at each of one or more waypoints before moving the component or the tool to a work start position of the predetermined work; and
after executing the waypoint following control, a work time following control which controls the arm to place the component or the tool at the work start position and which controls the arm to perform a work time following in which the component or the tool follows the object which is being moved.

8. The robot controller according to claim 7 comprising:
a display device capable of displaying a waypoint teaching screen for a teaching of the following control at each of the one or more waypoints; and
an input unit for performing an input for the teaching of the following control.

9. The robot controller according to claim 8, wherein
the display device is capable of displaying a screen for designation of a following direction for each of the one or more waypoints, the following direction is a direction in which the following control is to be performed, and
the controller is configured to cause the arm to follow each of the waypoints in a direction corresponding to the designation.

10. A work robot system comprising:
an object conveying device for conveying an object;
a robot having an arm; and
a controller configured to control the arm to perform a predetermined work on a target portion of the object which is being moved by the object conveying device, wherein
the controller is configured to perform:
a waypoint following control which controls the arm so that a component or a tool supported by a distal end portion of the arm follows the object, which is being moved, at each of one or more waypoints before moving the component or the tool to a work start position of the predetermined work; and
after executing the waypoint following control, a work time following control which controls the arm to place the component or the tool at the work start position and which controls the arm to perform a work time following in which the component or the tool follows the object which is being moved.

11. The robot system according to claim 10, wherein the controller stores an operation program that causes the arm to perform a predetermined operation, and
the controller is configured not to cause the component or the tool to follow the object in a predetermined direction when the following control is performed while moving the component or the tool in the predetermined direction by the operation program.

12. The work robot system according to claim 10 or 11 comprising:
a display device capable of displaying a waypoint teaching screen for a teaching of the following control at the one or more waypoints; and
an input unit used for the teaching of the following control at the waypoint teaching screen, wherein,
the controller is configured to perform the waypoint following control using visual feedback based on an output of a sensor, and
the controller is configured to perform:
an image acquisition process which causes the sensor to acquire an image based on an input to the input unit in a state where the distal end portion of the arm is disposed at a position corresponding to each of the one or more waypoints; and
a following target setting process which sets a part or all of the object shown in the acquired image as a following target of the waypoint following control.

13. The work robot system according to claim 12, wherein the controller is configured to control the arm so that a position of the following target and a portion to be followed in the component or the tool are aligned to each other within a predetermined criteria in the images sequentially obtained by the sensor in the waypoint following control.
